(19) United States
(12) Patent Application Publication
(10) Pub. No.: US 2012/0252666 A1
(43) Pub. Date: Oct. 4, 2012

(54) THERMALLY SENSITIVE RECORDING MATERIAL

(76) Inventors: Andreas Kornherr, Wien (AT); Thomas Schalkhammer, Kasten (AT); Roland Palkovits, Wiener Neustadt (AT)

(21) Appl. No.: 13/510,974

(22) PCT Filed: Nov. 22, 2010
(86) PCT No.: PCT/EP2010/007053

§ 371 Date: May 21, 2012

(30) Foreign Application Priority Data
Nov. 24, 2009 (EP) 09014587.1

(51) Int. Cl. B41M 5/32; B41F 33/00; B41M 5/333; B41M 3/00

(52) U.S. Cl. 503/208; 427/150; 101/483

(57) ABSTRACT

The present invention provides a heat-sensitive recording material, characterized in that a carrier material carries at least one coating layer in which at least two colour-forming reactants A and B are contained, wherein the layer contains a water-insoluble or sparingly water-soluble iron compound as colour-forming reactant A and a water-insoluble or sparingly water-soluble phenol compound having 2 or more adjacent OH groups as reactant B separated from each other, wherein at least one of the compounds melts at less than 100° C. and this melt reacts with the other colour-forming reactant by colour development in less than 1 second's contact time and at least one of the two colour-forming reactants is present as particles having a size of less than 20 μm.

Commonly used thermal papers are coated with protective layers and so have no toxic, skin-irritating or allergenic surface properties, but they do contain a multiplicity of concerning components and therefore are only approved for indirect food contact for example.

It is particularly the continuously growing thermal paper market that appears to be particularly problematic as regards sustainable use of resources. Thermal papers are used in all receipt printers, many fax machines and cheap printers for example. They contain, depending on make, several dozen chemicals, the ecological compatibility of which frequently leaves something to be desired.

Bisphenol A in particular is an environmental hormone and acts like oestrogen, the female sex hormone, and can thus influence the human hormone system. Bisphenol A is one of the chemicals with the highest production volume in Europe—every year 1.15 million tonnes of the basic substance are consumed. More than 90 percent of the bisphenol A is used as starting material for producing polycarbonate plastics and paints—but humans come into contact with the chemical via thermal paper also.

Thermal papers have become indispensable in many areas of ordinary life. As entrance tickets, receipts or price labels in the supermarket, as travel tickets as well as in many other applications where information has to be printed out quickly and primarily by technically untrained staff. There is continuous investment in the thermal sector to satisfy the ever increasing demand.

In thermal printing, the text or image is produced by direct transfer of heat to thermal paper. This is accomplished via the thermal head of the printer, which consists of many small heating elements. These heating elements are under electronic control and generate thermal energy to induce the colour reaction on the functional thermal coating and thus produce text, barcodes or graphics.

Thermal papers consist of a high-quality base paper specially developed for thermal technology. A pre-coat is applied in the papermaker's machine as a prerequisite for a high quality of image in that it prevents heat conduction into the paper and supports the satisfactory functioning and the sensitivity properties of the thermal coat thereabove. The thermal coat contains the essential, functional constituents such as colour-formers and colour-developers. Pointwise transfer of heat from the thermal printer to the thermal coat elicits a chemical reaction which causes development of the text or picture. In addition, thermal papers may further be provided with a protective layer on the front or back. A topcoat on the front is sensible if the paper is exposed to mechanical stress, chemical influences or environmental influences. A backcoat provides additional protection during printing, laminating and so on and so forth.

A basic prerequisite for a perfect print is that the right paper is chosen for the printer and for the application. Sensitivity is pivotal for this selection. There is static sensitivity and there is dynamic sensitivity. Dynamic sensitivity is particularly important for selecting the right paper for a particular printer. The faster the operating speed of the printer, the shorter the residence time underneath the thermal printhead. A high-speed printer therefore requires a paper of high dynamic sensitivity. If the sensitivity of the thermal paper used is too low, the heat will not be sufficient to produce an image with complete blackening, thereby reducing the durability of the image. Static sensitivity indicates the onset temperature for the blackening of a thermal paper. The static sensitivity value is important when the paper is exposed to comparatively high ambient temperatures in the parking ticket sector for example.

Assuming proper storage, differing durability of up to years can be achieved, depending on the product. However, various environmental influences can substantially reduce the durability of the printed image in that in reality the prints are often illegible after a few years. Prints in plastic sleeves turn black or, if adhered atop a substrate, spotty. Factors limiting print durability include for example moisture, heat, oily and fatty compounds, solvents and plasticizers. A simple example is a sales slip in a plastic bag turning black as a result of the diffusing plasticizers.

Thermal papers can be printed on the reverse side as well as the functional side depending on the printing process used. In general, care must always be taken with printing the thermal layer to ensure that the machine settings are appropriate to the paper. Printing inks, however, have to be compatible with the thermal layer irrespective of whether the thermal side or the reverse side is printed. Thermal paper makers collaborate with various thermal head, printer and printing assembly makers in order to optimize the thermal paper types and the appliances to one another. Equipment manufacture approvals are preceded by extensive tests to ensure a long life for the thermal printers or individual components while consistently producing a high-quality print. Type- and equipment-dependent approvals are available from IBM, Epson, Seiko, MWCR, Hengstler or Mettler-Toledo. Furthermore, ongoing production is subjected to various extensive tests at regular intervals to ensure that optimum printing and long component life can be guaranteed on all appliances.

In addition to till rolls in the POS sector, the preferred fields of application are ATM receipts or else diagram paper for medical recording equipment. The sensitivity is sufficient to ensure optimum printing on virtually all thermal printers available.

There is also two-sidedly coated thermal paper, i.e. both sides of the paper bear a functional thermal coat. This functional thermal coat only works in dedicated thermal printers and then allows simultaneous printing on the front and back of till rolls for example. Some papers are available in any desired colours as well as in white, or are additionally offset printed.

In addition, thermal labels have become virtually indispensible in sales, logistics, haulage and despatch as well as in industry in general on account of the many advantages of thermal printing. Since a label primarily serves as a carrier of information, all data have to be printed onto the label, including the barcode. Stable thermal paper is used as cinema ticket, as travel ticket or as betting slip—applications where good stability, durability and printability are essential. The paper is often endowed with security features such as UV fibres or magnetic particles to render it forgery proof.

A heat-sensitive method of recording which is currently in standard use utilizes a layer whose main components are a leuco dye, which is colourless or slightly coloured at room temperature, and a colour-developer, such as an organic acidic material, and which is capable of eliciting colour formation on heating by reacting the leuco dye. The heat-sensitive recording layer is produced by adding a sensitizer to the abovementioned leuco dye and colour-developer to produce a heat-sensitive recording material.

The patent publications EP-A-0 968 837, U.S. Pat. No. 5,256,621 and U.S. Pat. No. 6,093,678 can be mentioned among others as examples of patent literature relating to heat-sensitive recording material. Similarly, U.S. Pat. No. 4,849,396, U.S. Pat. No. 5,446,009, EP-A-0 526 072 and WO-A-0035679 describe the prior art in connection with the use of metal salts in particular. The two first-cited publications utilize a colour formation system of the metal chelate type either alone or with conventional leuco dye and developer. The two last-cited publications utilize urea-based chemicals. U.S. Pat. No. 4,849,396 (Jujo Paper) relates to a thermal paper where the printed image is produced by using a colour formation system of the metal chelate type.

Known are reactive inks (GB1469437, 1977-04-06, OZALID CO LTD; LANDAU R of Ink OZALID CO Ltd), which on application to an alkaline surface provide a coloured printout from a precursor. An aqueous solution contains a chelate of iron or of titanium, a polyhydroxy compound (tannin, pyrocatechol, pyrogallol, gallic acid or water-soluble derivatives), ascorbic acid and the sodium salt of chromotropic acid. A typical ink contains water, iron ammonium oxalate, iron EDTA, titanium potassium oxalate, oxalic acid, citric acid, tannin, the sodium salt of chromotropic acid, pyrogallol, ascorbic acid, pyrocatechol, ethylene glycol and sorbitol.

Known are invisible inks (GB1292831, 1972-10-11, MEREDITH CORP (US) and FR2028486 (A1) and DE1946393 (A1)) with a phenolic or enolic group which reacts with an oxidizing ion of a metal to achieve the formation of a colour. Admixed are a binder and a carrier solvent. The reactive component is, for example, gallic acid, propyl gallate, acetoacetate, phenol, resorcinol, cresol, vanillin, guaiacol or zinc resorcinate. The developers used are iron salts, oxidizing salts of metals, citric acid or lead ions and Congo Red or xylenol orange. The binders used are polyvinylpyrrolidone, cellulose hydroxypropoxy ether or polyamide. Carriers are glycols, glycol ethers, esters and ether alcohols. Optional additives are fluorophores e.g. methyl umbelliferone, citric acid, fillers e.g. silica or silicates, antioxidants and UV stabilizers e.g. 2,4-dihydroxybenzophenone.

Also known are other invisible inks e.g. (GB1350930, 1974-04-24, DICK CO AB also NL7103180 (A), FR2084649 (A5), DE2112380 (Al) from A B DICK CO) which in addition to gallic acid contain leuco dyes for example.

Known are heat-sensitive inks (JP2265978, 1990-10-30, MATSUSHITA TOSHIHIKO; MORISHITA SADAO, MITSUBISHI PAPER MILLS LTD) using an aromatic isocyanate component, an imino component, an organic solvent and gallotannin or methyl gallates, ethyl gallates, trimethoxygallates or gallius acid 3-methyl ether.

Known are recording inks (JP58183769, 1983-10-27, AKUTSU HIDEKAZU; FUJII TADASHI; MURAKAMI KAKUJI; ARIGA TAMOTSU; KAZAMI TAKEO of RICOH KK) of an N-alkanolamine salt of m-digallic acid to enhance the water fastness of a coloured material without changing the solubility of the dye.

Known are inks wherein phenolic components (preferably gallic acid and pyrogallol) are contained (JP57207659, 1982-12-20, OOWATRI, of EPSON CORP) to provide the print with rapid drying and not to clog the printer nozzle and free of dissolved oxygen with a pH of 12-14. Also known is a coloured ink (JP9059547, 1997-03-04, KAWASHIMA SEIJI) which uses a colourless ink consisting of e.g. zinc chloride, salicylic acid, tannin or the like with a colorant as electron-donating component and the colour is decolorized by addition of water. Known are inkjet inks consisting of the tannin from persimmon (KR20040012361, 2004-02-11, SON GYU, YOUNGDONG AGRICLTUVAL) as replacement for customary tannin, with reduced production costs and a secure supply position. The ink contains various components including water, organic solvents, dyes, tannin, extract from persimmon containing gallic acid, ellagic acid and catechin.

Known is an inkjet ink said to prevent the clogging of nozzles (JP2005272762, 2005-10-06, KONO MONICHIRO; IIDA YASUHARU of TOYO INK MFG CO).

The ink contains 0.3-10 wt. % of food colour, 45-98.7 wt. % of ethanol, 0.5-5 wt. % of tannin, 0-30 wt. % of propylene glycol, 0.5-5 wt. % of sodium lactate and 0-5 wt. % of water.

Known is a recording material for inks (JP1241487, 1989-09-26, HAYAMA KAZUHIDE; YAMASHITA AKIRA of MITSUBISHI PETROCHEMICAL CO) which contains 0.1 to 30% of a component having a phenolic OH group, and also a binder of 5-95 wt. % of polyvinyl alcohol and 95-5 wt. % of a cationic water-soluble resin. The phenolic component has at least two hydroxyl groups for example hydroquinone, tannin, resorcinol, di-t-butylphenol, phloroglucinol or bis(4-hydroxyphenol)methane.

Known is a colour-reactive typing paper (GB856188, 1960-12-14, NEALE DAVID JOHN of CARIBONUM LTD) using a colourless “inked ribbon” and an impregnated paper primarily with molybdates and tungstates.

Known is an inkjet paper (JP57087987, 1982-06-01, MURAKAMI MUTSUAKI; SEKIGUCHI YUMIKO of MATSUSHITA ELECTRIC IND CO LTD) with improved light stability on wood-free paper through metallic oxides and the like e.g. tungsten phosphate, metallic chlorides (e.g.: chromium chloride) and or tannin with PVA binder and a white filler (e.g. calcium carbonate etc.).

Known is a copier system (GB191016515, 1911-06-08, CAMERON DUNCAN) using moist tannin- or gallic acid-impregnated paper for making copies of texts written in iron gall ink. Sodium sulphite, borax and phenol serve as additions.

Known is a copier process (GB943401, Feb. 11, 1959, IMAGIC PROCESS Ltd, also NL267030 (A), NL248292 (A), GB991599 (A), BE595169 (A), DE1269630 (B1)) using iron sulphate or chromates as developers and polyphenol, pyrogallic acid or tannin.

Known is a thermal method of recording (JP4307289, 1992-10-29, MORITA YASUYOSHI; MURATA TATSUYA; KOYABU KYOKO of OJI PAPER CO) with a two-layered construction wherein one layer contains an iron salt of a fatty acid and a gallic acid derivative and the second layer contains an electron donor colour precursor.

Known is a pressure-sensitive recording layer (JP1271284, 1989-10-30, TAJIRI MASANAO; SHINKOU KAZUYUKI; SHIOI SHUNSUKE of KANZAKI PAPER MFG CO LTD) using microencapsulated reactants: 1.) electron-transferring colour former 2.) ligand with phenolic OH groups (e.g. gallates, salicylic acid, . . . ) and 3.) desensitizer with 4.) an iron(III) coating layer. Known is a thermal method of recording (JP60083886, 1985-05-13, MATSUSHITA TOSHIHIKO; MORISHITA SADAO of MITSUBISHI PAPER MILLS LTD) with a layer of alkyl gallates with a melting point of 60-180° C. and a receiving layer consisting of iron salts (preferably as dispersion of iron stearate). Known is an analogous thermal method of recording (JP60083885, 1985-05-13, MATSUSHITA TOSHIHIKO; MORISHITA SADAO of MITSUBISHI PAPER MILLS LTD) or JP60063192 (1985-04-11, MATSUSHITA TOSHIHIKO; MORISHITA SADAO of MITSUBISHI PAPER MILLS LTD).

The invention has for its object to provide a thermal paper having a heat-sensitive coating which contains distinctly low toxicity and fewer allergy-triggering components and which causes less environmental pollution than the known thermal papers based on leuco dye.

The material shall nonetheless:
show high static and dynamic colour-conferring sensitivity
be applyable without greying in production, and more particularly
have a distinctly longer durability than leuco dye thermal papers.

The present invention relates to a heat-sensitive recording material. More particularly, the invention relates to a heat-sensitive recording material that has improved durability of a legible printed image and is ecologically compatible.

The present invention accordingly provides a heat-sensitive recording composition according to claim 1 and a heat-sensitive recording material using the recording composition according to the invention.

The structure of the heat-sensitive recording material is such that a heat-sensitive recording layer capable of causing colour development by heating is provided on a carrier substrate.

Useful carrier substrates include essentially single- or multi-layered materials in the form of sheeting, such as paper, synthetic paper or optionally coated polymeric film/sheet.

The main layers of the recording material according to the invention are at least raw paper, raw plastic or a corresponding material and the coating according to the invention. The main layers may additionally comprise pre-coating and/or surface coating on one or both of the sides of the sheeting. The coat at least includes a colour-former, a developer and a binder. On heating to a suitable temperature, at least a portion of the components melts and thus allows reactions of other components of the coat, the consequence of the chemical reaction being that a colour becomes visible to the naked eye.

A thermal printer equipped with a thermal head is usually used as heating means to elicit colour development.

The heat-sensitive recording system using the abovementioned heat-sensitive recording material is advantageous to other conventional recording systems since the steps of development and image fixation (see laser or the like) are not necessary, recording is easily achievable using a comparatively simple apparatus, and service costs can be reduced.

A heat-sensitive recording material is produced by using a spread-coating machine to apply a coat to a suitable web of raw paper, to a polymeric film, to a resin-coated paper or to a corresponding material and subsequently drying and calendering the sheeting in most cases. The coat used is normally produced by at least one colour-former, at least one metal salt (reactant A) and a reactant B being separately pulverized or micronized to produce a dispersion.

The two reactants are ground to a suitable particle size to ensure short diffusion pathways and hence rapid response of the material. The disperse mixture obtained in this way is mixed with the binder and other auxiliary materials and applied using the spread-coating machine.

The invention provides that reactants shall be used for an environmentally friendly thermoprinting process which are biodegradable and contain ubiquitous metals without toxic properties.

Natural tanning substances and, based thereon, colour-couplers and also iron, as a nontoxic metal.

The two reactants are preferably incorporated in a layer microencapsulated with a binder and protected against diffusion of components. Thermal heating to less than 100° C., preferably less than 90° C. will melt at least one of the two reactants, which then reacts in an organic melt with the other reactant.

Reactant B utilizes essentially metal-chelating/complexing di- or polyhydroxycarboxylic compounds which have 2 or more adjacent OH groups.

Tanning substances are a heterogeneous group of usually di- or polyphenol compounds, the largest group of which is that of the gallic acid descendents. Gallates are synthetic derivatives of gallic acid. The gallates which are most important and are even permitted under the German Food Act are: propyl gallate (E 310), octyl gallate (E 311) and dodecyl gallate (E 312). Gallates are predominantly used as antioxidants in the fatty phase as well as in food products and medicinal products.

Colouring products which are bluish black are also formed on addition of iron(III) salts to tanning substances, such as extracts from the bark of oak, spruce, larch, black alder, leaves and fruits of many sumac species (e.g. the Eurasian smoketree) and of black tea. The plant parts mentioned contain particularly many tannins (tanning substances). Tanning substances occur widely in the vegetable kingdom.

These above all comprise di- or polyphenols (aromatic systems having two or more hydroxyl groups), which are usually derivable from gallic acid and are often condensed with other phenols and sugars.

In the present invention, these raw materials are hydrophobic or are hydrophobicized by, in particular, esterifying the phenolic groups or acids, and constitute the reactant B.

Lauryl gallate, octyl gallate, propyl gallate, ethyl gallate or methyl gallate are examples of suitable compounds.

These compounds are advantageously used as solution in or as suspension with a low-melting carrier material.

The melting point of the carrier material is preferably below 100° C. and more preferably below 80° C.

Free fatty acids, such as lauric acid, myristic acid, palmitic acid or behenic acid, are suitable carrier materials.

Iron is an essential trace element in man. Iron is, for example, a constituent of the blood dye haemoglobin and responsible for oxygen transport in blood. Iron occurs in several oxidation states, although only Fe2+—ferrous iron- and Fe3+—ferric iron—have any importance for the organism; higher valences are unstable and constitute strong oxidizing agents. Iron is usually in ferrous form in the absence of oxygen and then acts as a reducing agent. In the presence of air, ferrous iron rapidly converts into Fe3+ compounds, which are terminal electron acceptors. While Fe2+ salts are readily soluble, most Fe3+ salts are sparingly soluble at neutral pH. Oxalates are examples of soluble iron salts—insoluble iron salts are known to be solubilizable and partially decolorizable with oxalic acid—this can be exploited with advantage to recycle the thermal papers according to the invention.

Since most iron salts and the familiar iron gall ink are generally hydrophilic, salts of ferric iron with long-chain fatty acids are used in the invention to convert the iron into a fat-soluble form which can react with the hydrophobic tanning substances in an organic phase by complex and colour formation.

Suitable for the purpose are for example iron behenate, iron stearate, iron palmitate, iron myristate, iron dodecylate, iron-zinc stearate, iron-zinc montanate, iron-zinc behenate, iron-calcium behenate, iron-aluminium behenate and iron-magnesium behenate.

The reaction here also proceeds without water—the choice of two water-soluble reactants would require water or analogous co-reactants to form the dye as well as incur less favourable health-relevant properties.

The reactants are processed into particles not more than 20 μm in size to produce the recording material. Grinding, spray drying, spray solidification or processing using vibrating or rotating pan atomizers are examples of suitable methods of processing.

To prevent premature contact between reactants A and B in the coating, at least one reactant may have a protective sheath or coating against diffusion. This coating/sheathing on particles preferably consists of a suitable polymer, for example polyacrylamide, polyacrylic acid, dextrin, starch or else of inorganic salts, ceramics, quartz, silicates or aluminium oxide.

The particles are coated onto paper, corrugated board or cardboard using the paper coating processes customary in the paper industry, especially the last paper coating steps. Paper coating processes of this type are known from the prior art and familiar to a person skilled in the art.

The composition according to the invention can be applied to the carrier substrate by other printing, painting or paper technology processes such as blade coating, spraying, dip coating or common printing processes, such as gravure, flexographic, screen, offset or digital printing, curtain coating or roll application processes with roll co- or contrarotation.

Irrespective of the carrier material, it advantageous for the particles to be bound to the surface of the coated material with an adhesive, for example with a glue based on starch or on biocompatible and/or biodegradable polymers. A person skilled in the art is familiar with adhesives of this type from the prior art.

Optionally, the coating composition may include stabilizers to inhibit greying or browning, especially on exposure to the agency of moisture and/or heat.

Suitable stabilizers are pH stabilizers, reducing agents and polymerization inhibitors, preferably polymers such as polyacrylamides and strong or medium non-volatile acids.

The technological innovations of the present invention are:
Colour-stable, non-bleachable printed paper, film/sheet and surfaces of materials
Production and alteration of colour by local transfer of heat
Freely choosable colours without toxic organic chemicals
Any build is very gentle on the material due to nanometrically thin layers

The sources of energy which are needed for thermal scribing preferably have low thermal divergence, a high energy density (due to the strong bundling and the self-amplification of the energy) and large coherence in time and space. Lasers are also primarily suitable as light sources as a result as well as thermal heads. Other thermal sources of light are also useful after suitable optical processing (LEDs, high energy lamps with Hg, or metal vapour and so on), but their energy density is often low. Thermal inducement of the effect due to a hot surface is likewise possible and can be effected via thermal stamps or rolls.

The thermal intensity can be controlled to be purely black/white (or two-coloured) or is policed by assigning a percentage of the intensity from 0-100% to every colour used in the graphic drawing. Since the thermal head is intensity controlled by proportional pulsing or in some other way, this percentage indicates how long the heat pulses last or how high the intensity of the application of heat is. In principle, the intensity setting is directly based on the depth of the colour effect.

High-temperature effects create toxic fumes and changes in materials and are undesired/unacceptable in an office environment. The thermal printer must therefore produce nanothin chromophoric layers at material surface temperatures of typically less than 100° C. without significant evolution of ablation products.

System total energy requirements result primarily only from the thermal power output plus waste heat, the energy requirements of the forward feed are insignificant by contrast, no additional fixing of the toner with heat is primarily contemplated, but it can be secondarily combined with the process. Therefore, the printer primarily only has energy requirements in direct printing operation. Typical printers currently have power requirements between about 5 and 30 watts in standby and up to 1000 W in printing. The thermal printer's lower energy requirements and absence of any heat-up time to the first sheet also mean that it clearly stands out from existing printing processes.

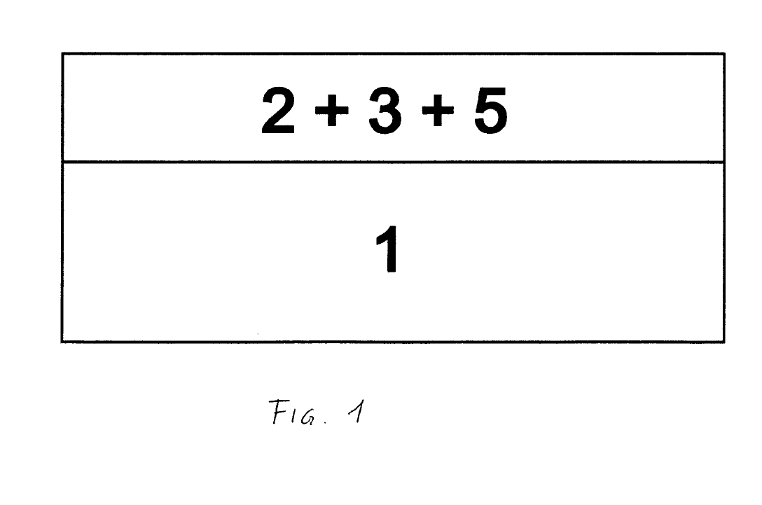

FIGS. 1 to 7 depict the recording material according to the invention:

The reference symbols are assigned as follows:
1. Carrier material
2. Reactant A
3. Reactant B
4. Diffusion control sheath
5. Binder

The colour-formers used are the two described groups of substances, which form a coloured complex of a metal after reactions. Specific exemplary embodiments possible are as follows:

FIG. 1:

This embodiment shows a simple mixture of colour-formers (2,3) with the binder (5). Reaction due to internal diffusion is inevitable here—the paper darkens subsequently and is not stable in the long run.

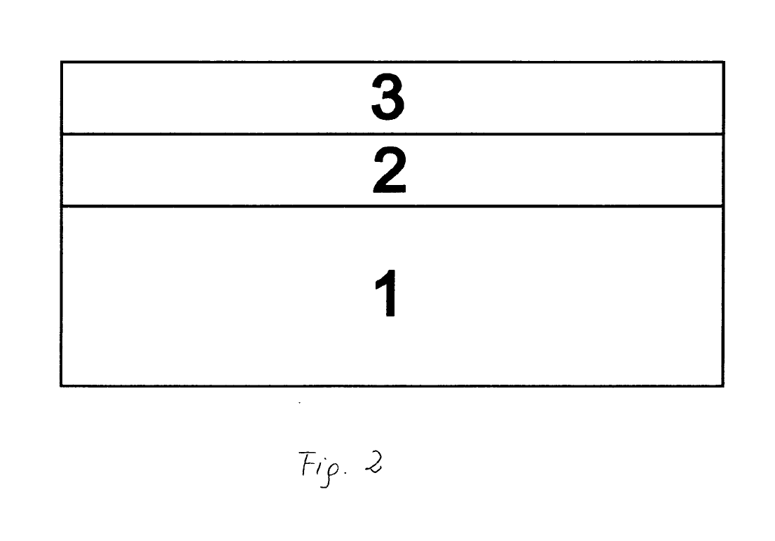

FIG. 2:

This embodiment shows a simple sequential application of colour-formers (2,3) perhaps mixed with the binder (5). Reaction due to internal interfacial diffusion is inevitable here—the paper darkens subsequently—albeit not as severely as that depicted in FIG. 1 and is not stable in the long run.

More particularly, the colour reaction is slow and weak, since the components are some μm apart from each other.

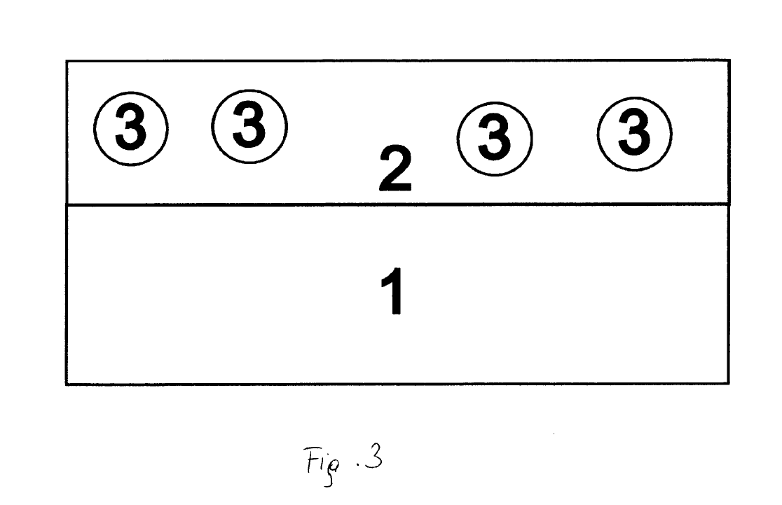

FIG. 3:

This embodiment shows application of the colour-former (3) as a dispersion in colour-former (2) perhaps mixed with the binder (5). Moderate reaction due to interfacial diffusion is inevitable here—the paper darkens subsequently—albeit not as severely as the embodiment depicted in FIG. 1 and is moderately stable. Unlike the embodiment depicted in FIG. 2, the colour reaction is intensive and rapid, since the components are in a highly disperse state.

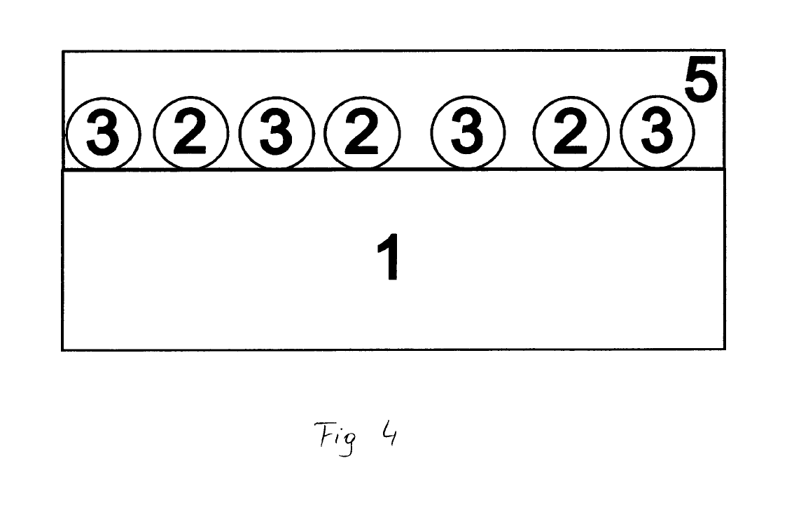

FIG. 4:

This embodiment shows application of the two colour-formers (2+3) as a dispersion in binder (5).

Interfacial diffusion gives rise to a weak non-specific reaction here—the paper subsequently darkens only to a slight degree and is relatively stable. Unlike the embodiment depicted in FIG. 2, the colour reaction is intensive and rapid, since the components are in a highly disperse state.

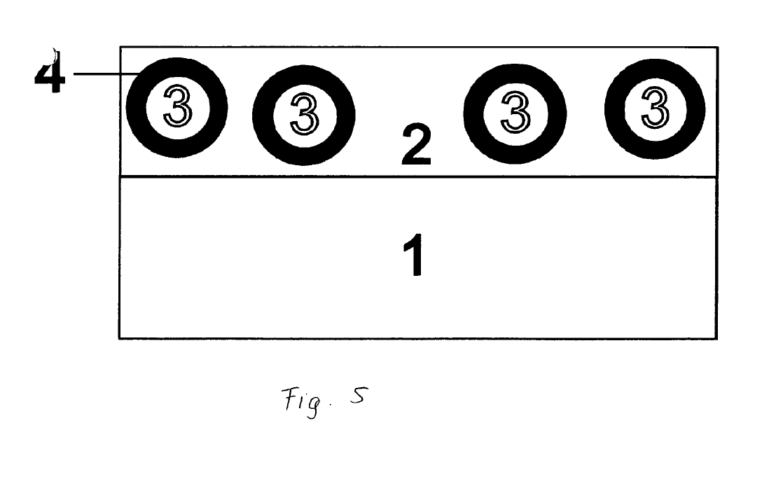

FIG. 5:

This embodiment shows application of colour-former (3) as a dispersion in colour-former (2) perhaps mixed with the binder (5). Reaction due to interfacial diffusion is avoided here by sheathing the dispersed phase with a barrier (4)—the paper does not darken subsequently and is stable. Unlike the embodiment depicted in FIG. 2, the colour reaction is intensive and rapid, since the components are in a highly disperse state.

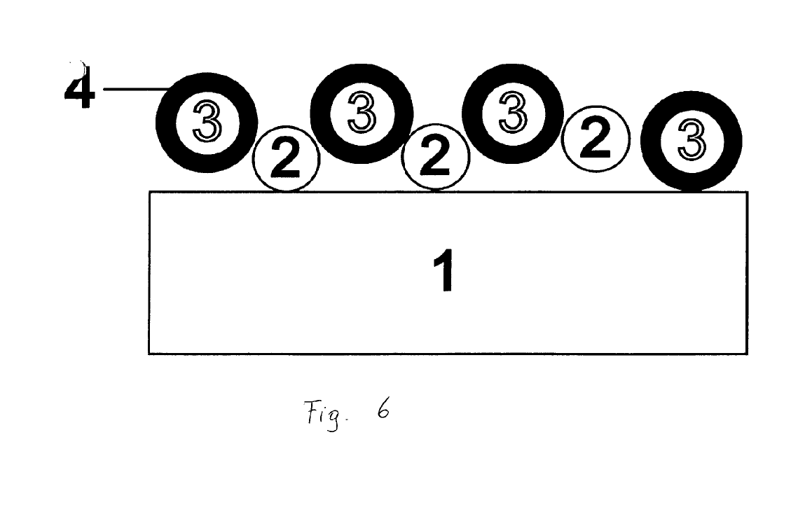

FIG. 6:

This embodiment shows application of the two colour-formers (2+3) as a dispersion. Reaction due to interfacial diffusion is avoided here by sheathing the dispersed phase with a barrier (4)—the paper does not darken subsequently and is stable. Unlike the embodiment depicted in FIG. 2, the colour reaction is intensive and rapid, since the components are in a highly disperse state. Which of the two colour-formers carries the barrier coating and whether perhaps both carry a coating, can be varied according to the intended use.

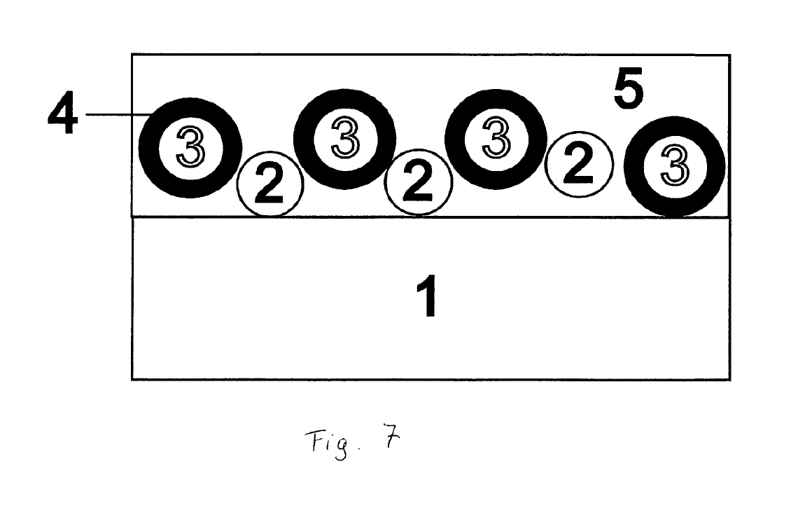

FIG. 7:

This embodiment shows application of the two diffusion-blocked colour-formers (2+3) as a dispersion in binder (5) similar to FIG. 6.

### EXAMPLES

### Example 1

### Synthesizing a Finely Disperse Optimally Melting Hydrophobic Iron Compound

A water-soluble salt of iron (usually iron(III) sulphate, iron(III) chloride, iron(III) ammonium sulphate) is reacted in an aqueous solution with an organic solution of a long-chain preferably aliphatic acid (usually lauric, myristic, palmitic, stearic or behenic acid). The insoluble iron salt precipitates and is separated off.

The reaction may similarly also be carried out without solvent, in the melt, if desired.

The iron salt is then melted and atomized in a rotating pan atomizer to form a few μm-sized particles, which are usually briefly washed. The molar ratio of the reactants is usually chosen such that the melting point of the resulting mixture of iron salt and usually excess acid is in the ideal thermal-printer melting range of usually 60-90° C.

Alternatively, the salt can also be ground, in which case the wax-type consistency must be taken into account in the grinding.

### Example 2

### Synthesizing a Finely Disperse Optimally Melting Hydrophobic Gallic Acid Compound

A gallic acid salt that preferably melts below 100° C.-usually lauryl gallate—is finely atomized from a melt on a rotating pan atomizer. An addition of lauric, myristic, palmitic, stearic or behenic acid controls the melting point of the resulting particles.

### Example 3

### Synthesizing Finely Disperse Enveloped Particles

A particle formulation from Example 8 and/or 9 that melts below 100° C. is encapsulated with a diffusion control sheath. An aqueous dispersion of the particles is mixed with a suitable polymer and usually needed detergent and dried in a spray dryer under mild conditions to form particles enveloped with a polymer (e.g. polyacrylic acid, polyacrylamide, dextrin, starch, . . . ). Alternatively, the particles can also be coated with a thin layer of quartz, aluminium oxide and the like by sol-gel processes. Similar precipitation processes as diffusion barrier layers from effect pigment technology are likewise usable (precipitative coating).

### Example 4

### Additions and Binders

Any customary paper industry binder can be used, in which case the gallic acid compound can be made resistant to yellowing by adding amides—preferably polyamides and using an acidic pH. Particularly suitable for this purpose are polyacrylamide and phosphoric acid at a pH below that of free gallic acid.

1. Heat-sensitive recording material, characterized in that a carrier material carries at least one coating layer in which at least two colour-forming reactants A and B are contained, wherein the layer contains a water-insoluble or sparingly water-soluble iron compound as colour-forming reactant A and a water-insoluble or sparingly water-soluble phenol compound having 2 or more adjacent OH groups as reactant B separated from each other, wherein at least one of the compounds melts at less than 100° C. and this melt reacts with the other colour-forming reactant by colour development in less than 1 second's contact time and at least one of the two colour-forming reactants is present as particles having a size of less than 20 μm.

2. Heat-sensitive recording material according to claim 1, characterized in that the iron salt has a melting point of 40 to 120° C., preferably from 45 to 80° C., and is selected from the group containing iron behenate, iron stearate, iron palmitate, iron myristate, iron dodecylate, iron-zinc stearate, iron-zinc montanate, iron-zinc behenate, iron-calcium behenate, iron-aluminium behenate and iron-magnesium behenate.

3. Recording material according to claim 1, characterized in that the reactant B is a sparingly water-soluble aromatic di- or polyhydroxy compound having a melting point of 40 to 120° C. which forms coloured metal chelates.

4. Recording material according to claim 1, characterized in that reactant B is a lauryl gallate of 95° C. melting point, an octyl gallate having a melting point of 102° C., a propyl gallate having a melting point of 147° C., an ethyl gallate having a melting point of 150° C. or a methyl gallate having a melting point of 203° C.

5. Recording material according to claim 1, characterized in that the reactant B is present as solution in or suspension with a low-melting carrier material having a melting point below 100° C. preferably below 80° C. and free fatty acids especially lauric acid, myristic acid, palmitic acid or behenic acid are preferably used as carrier material.

6. Recording material according to claim 1, characterized in that the two colour-forming reactants have been applied to the carrier material as intimately mixed micro- or nanopowders but without direct contact between the two powders.

7. Recording material according to claim 1, characterized in that the colour-forming reactants are either or both surrounded with a protective sheath against diffusion of components.

8. Recording material according to claim 1, characterized in that iron laurate and lauryl gallate micropowders have been applied to paper as carrier material intimately mixed with a polymeric or disperse protective chemical against diffusion of the two reactants with a binder, preferably starch.

9. Recording material according to claim 1, characterized in that the iron salt is prepared synthetically by reaction of at least partially water-soluble iron salts with long-chain fatty acids, with a chain length of at least 10 carbon atoms and are preferably separated from a water-containing solution by precipitation.

10. Recording material according to claim 1, characterized in that the iron salts of long-chain fatty acids are present as micronized powder less than 20 μm in size alone or together with a wax-type component, preferably likewise a long-chain fatty acid or compounds thereof.

11. Recording material according to claim 1, characterized in that the reactant A are micronized by spray drying, spray solidification, grinding or vibrating or rotating pan atomizers.

12. Recording material according to claim 1, characterized in that the protective sheath against diffusion of components consists of a hydrophilic coating in which at least one of the two colour-forming reactants, preferably both, are not soluble, preferably hydrophilic polymers, more preferably polyacrylic acids or polyacrylamides or inorganic salts or ceramics, more preferably quartz.

13. Recording material according to claim 1, characterized in that the reactive layer contains stabilizers to prevent greying or browning especially in wet-moist heat, preferably pH stabilizers, reducing agents and polymerization inhibitors, preferably polymers such as polyacrylamides and strong or medium non-volatile acids.

14. Process for preparing a recording material according to claim 1, characterized in that the reactive layer is applied to the carrier material by printing, painting or paper technology processes such as blade coating, spraying, spread coating, dip coating or common printing processes, such as gravure, flexographic, screen, offset or digital printing, curtain coating or roll application processes with roll co- or contrarotation.
